(19) United States
(12) Patent Application Publication
(10) Pub. No.: US 2008/0049181 A1
(43) Pub. Date: Feb. 28, 2008

(54) PANEL ASSEMBLY

(75) Inventors: Seon-Ah CHO, Busan (KR); Ji-Won SOHN, Seoul (KR); Mee-Hye JUNG, Suwon-si (KR); Sung-Hoon YANG, Yongin-si (KR); Jin-Won PARK, Suwon-si (KR); Dong-Gi SEONG, Suwon-si (KR); Kang-Woo KIM, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/933,398

(22) Filed: Oct. 31, 2007

Related U.S. Application Data
(63) Continuation-in-part of application No. 11/264,549, filed on Nov. 1, 2005.

(30) Foreign Application Priority Data
Nov. 21, 2006 (KR) 10-2006-0115470

(51) Int. Cl. G02F 1/1343

(52) U.S. Cl. 349/144; 349/139

(57) ABSTRACT

A panel assembly includes gate wires, data wires, a plurality of pixel electrodes, a liquid crystal layer, and a common electrode. The gate wires include a plurality of gate lines and a plurality of first storage electrode lines parallel to the gate lines. The data wires include a plurality of data lines crossing and insulated from the gate lines and a plurality of second storage electrode lines overlapping the first storage electrode lines and spaced apart from the data lines. The plurality of pixel electrodes are disposed on and insulated from the data wires. The liquid crystal layer is disposed on the pixel electrodes and includes liquid crystal molecules, and the common electrode is disposed on the liquid crystal layer. One of the plurality of first storage electrode lines and the plurality of second storage electrode lines has varying widths.

### CROSS-REFERENCE TO RELATED APPLICATION

This application claims priority from and the benefit of Korean Patent Application No. 10-2006-0115470, filed on Nov. 21, 2006, which is hereby incorporated by reference for all purposes as if fully set forth herein.

### BACKGROUND OF THE INVENTION

1. Field of the Invention

Apparatuses and methods consistent with the present invention relate to a panel assembly, and more particularly, to a panel assembly that may provide enhanced light transmittance.

2. Discussion of the Background

A display panel is employed in a display device and displays an image with a plurality of pixels. A pixel is the smallest unit to display an image. Among various display panels, a liquid crystal display (LCD) panel, which is thin and light, has been developed together with the rapid advancement in semiconductor technologies.

The LCD panel generally includes an upper panel assembly having a common electrode and a color filter, a lower panel assembly having a thin film transistor and a pixel electrode, and liquid crystals interposed between the upper and lower display panels. The pixel electrode and the common electrode receive different electric potentials to form an electric field, thereby adjusting the alignment of liquid crystal molecules and the light transmittance to form an image.

The LCD panel may provide a narrow viewing angle. To realize a wide viewing angle, a liquid crystal display panel in a vertically aligned (VA) mode has been developed, in which a single pixel is divided into a plurality of domains. In the VA mode, the longer side of the liquid crystal molecules is vertically aligned with respect to the upper and lower substrates when the electric field is not applied. The liquid crystal molecules in the VA mode may have various orientations near a fringe field formed in the plurality of divided domains, thereby enhancing the viewing angle.

However, the orientations of the liquid crystal molecules in some domains may also be affected by a fringe field formed near the boundaries of the pixels, thereby causing texture. Texture refers to dark space that appears when the alignment direction of the liquid crystal molecules is not controlled and becomes distorted.

Texture may appear on a boundary between the pixels when the alignment direction of the liquid crystal molecules is not controlled because of momentary voltage differences among neighboring pixels.

The appearance of texture lowers light transmittance and decreases the brightness of the display panel.

### SUMMARY OF THE INVENTION

The present invention provides a panel assembly that may provide enhanced light transmittance by efficiently controlling the alignment direction of liquid crystal molecules.

Additional features of the present invention will be set forth in part in the description which follows and, in part will be apparent from the description, or may be learned by practice of the present invention.

The present invention discloses a panel assembly including gate wires, data wires, a plurality of pixel electrodes, a liquid crystal layer, and a common electrode. The gate wires include a plurality of gate lines and a plurality of first storage electrode lines parallel to the gate lines. The data wires include a plurality of data lines crossing and insulated from the gate lines and a plurality of second storage electrode lines overlapping the first storage electrode lines and spaced apart from the data lines. The plurality of pixel electrodes are disposed on and insulated from the data wires. The liquid crystal layer is disposed on the pixel electrodes and includes liquid crystal molecules, and the common electrode is disposed on the liquid crystal layer. One of the plurality of first storage electrode lines and the plurality of second storage electrode lines has varying widths.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a first panel assembly of a panel assembly according to a first exemplary embodiment of the present invention.

FIG. 2 is a sectional view of the panel assembly which includes the first panel assembly according to the first exemplary embodiment of the present invention, taken along line II-II in FIG. 1.

FIG. 3 is a sectional view of the panel assembly which includes the first display panel according to the first exemplary embodiment of the present invention, taken along line III-III in FIG. 1.

FIG. 4 is a sectional view of the panel assembly which includes the first display panel according to the first exemplary embodiment of the present invention, taken along line IV-IV in FIG. 1.

FIG. 5 shows a first display panel of a panel assembly according to a variation of the first exemplary embodiment of the present invention.

FIG. 6 shows a first display panel of a panel assembly according to a second exemplary embodiment of the present invention.

FIG. 7 is a sectional view of the panel assembly which includes the first display panel according to the second exemplary embodiment of the present invention, taken along line VII-VII in FIG. 6.

FIG. 8, FIG. 9, and FIG. 10 show the panel assembly according to an Experimental Embodiment and a Comparative Embodiment of the second exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

The accompanying drawings show a panel assembly including amorphous silicon (a-Si) thin film transistor (TFT) formed by five mask processes. The present invention, however, may be realized as various types, and is not limited to the exemplary embodiments described in this application.
The accompanying drawings show a liquid crystal display panel in a vertically aligned (VA) mode in which a single pixel is divided into a plurality of domains.
To clarify the present invention, unrelated descriptions are avoided.

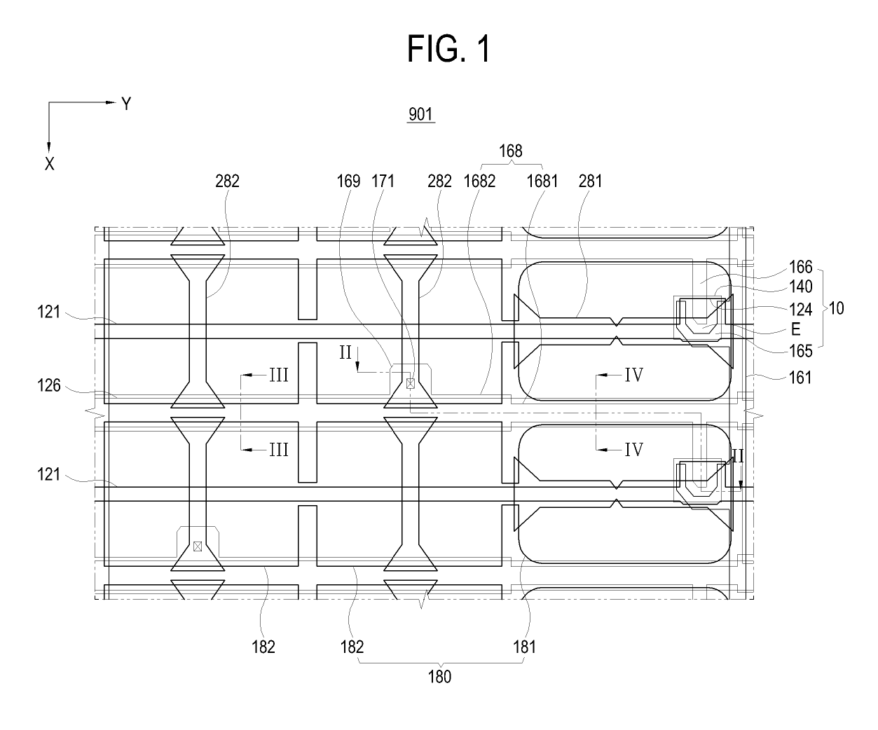

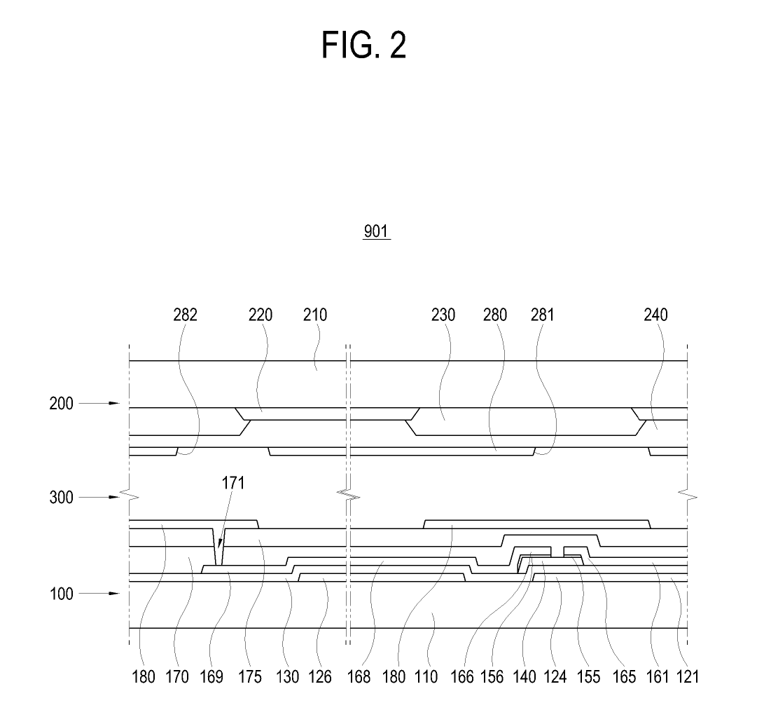

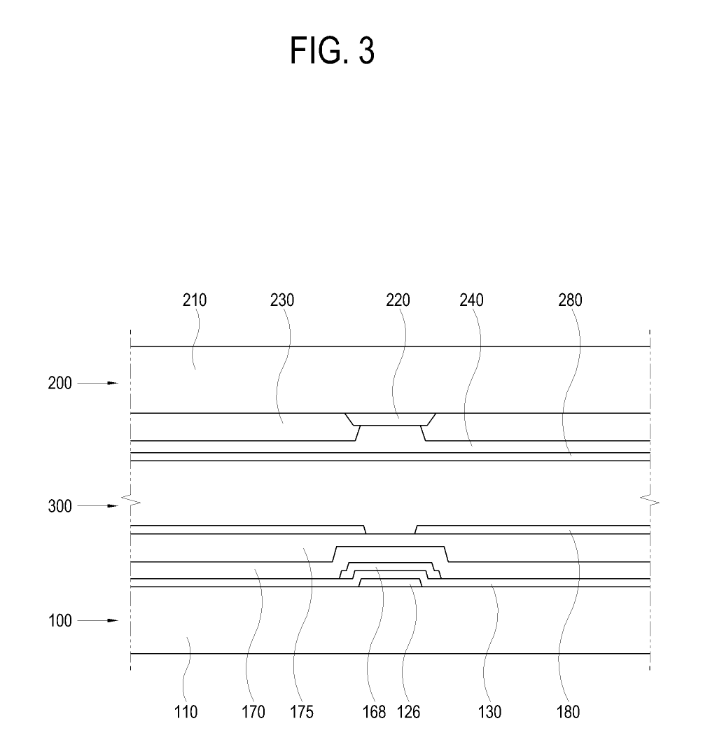

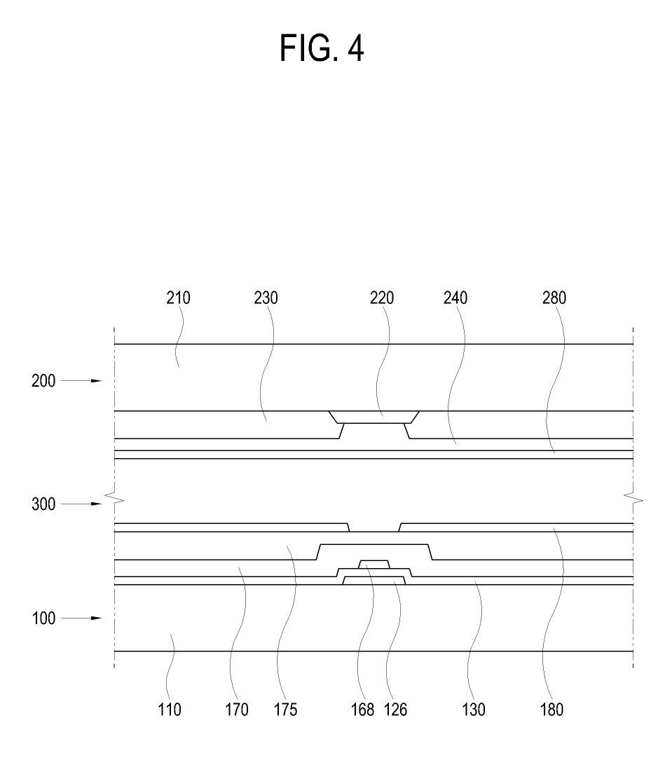

FIG. 1 shows a display panel 100 of a panel assembly 901 according to a first exemplary embodiment of the present invention. Also, FIG. 1 shows cutting patterns 281 and 282 of a common electrode 280 of a second display panel 200 that faces the first display panel 100. FIG. 2 is a sectional view of the panel assembly 901, which includes the first display panel 100 according to the first exemplary embodiment of the present invention, taken along line II-II in FIG. 1. FIG. 3 and FIG. 4 are sectional views of the panel assembly 901 according to the first exemplary embodiment of the present invention, taken along lines III-III and IV-IV, respectively.

The panel assembly 901 according to the first exemplary embodiment of the present invention includes a first display panel 100, a second display panel 200 that faces the first display panel 100, and a liquid crystal layer 300 that is formed between the first and second display panels 100 and 200 and includes a plurality of liquid crystal molecules. An alignment layer (not shown) may be formed in the first display panel 100 and the second display panel 200, respectively. The alignment layer vertically aligns the liquid crystal molecules of the liquid crystal layer 300 with respect to the first and second display panels 100 and 200.

The panel assembly 901 displays an image with a plurality of pixels. A pixel refers to the smallest unit to display an image. A single pixel has the same size as a pixel electrode 180.

Hereinafter, the first display panel 100 will be described in detail.

A first substrate 110 includes a transparent material, such as glass, quartz, ceramic, or plastic.

Gate wires 121, 124, and 126 are formed on the first substrate 110. The gate wires 121, 124, and 126 include a plurality of gate lines 121, a plurality of gate electrodes 124 branched from the gate lines 121, and a plurality of first storage electrode lines 126 parallel to the gate lines 121.

The gate wires 121, 124, and 126 include metal such as Al, Ag, Cr, Ti, Ta, Mo, or an alloy thereof. FIG. 2 shows the gate wires 121, 124, and 126 as a single layer. Alternatively, the gate wires 121, 124, and 126 may include multiple layers having metal layers, such as Cr, Mo, Ti, Ta, or an alloy thereof, which have good physical and chemical properties, and metal layers such as Al series or Ag series, which have low resistivity. The gate wires 121, 124, and 126 may include various metals or conductive materials, and multiple layers may be patterned under the same etching conditions.

A gate insulating layer 130 including silicon nitride (SiNₓ) is formed on the gate wires 121, 124, and 126.

Data wires 161, 165, 166, 168, and 169 are formed on the gate insulating layer 130. The data wires 161, 165, 166, and 168 include a plurality of data lines 161 crossing the gate lines 121, a plurality of source electrodes 165 branched from the data lines 161, a plurality of second storage electrode lines 168 overlapping the first storage electrode lines 126 and spaced apart from the data lines 161, and a plurality of drain electrodes 166 having a first side facing the source electrodes 165 and a second side connected to the second storage electrode lines 168. The data wires 161, 165, 166, 168, and 169 further include a plurality of connectors 169 branched from the second storage electrode lines 168.

The data wires 161, 165, 166, 168, and 169 include a conductive material, such as chrome, molybdenum, aluminum, or an alloy thereof. The data wires 161, 165, 166, 168, and 169 may include a single layer or multiple layers.

A semiconductor layer 140 is formed above the gate insulating layer 130 of the gate electrodes 124 and below the source electrodes 165 and the drain electrodes 166. Here, the gate electrodes 124, the source electrodes 165, and the drain electrodes 166 serve as three electrodes of a thin film transistor 10. The semiconductor layer 140 formed between the source electrodes 165 and the drain electrodes 166 defines a channel region E of the thin film transistor 10.

Ohmic contact members 155 and 156 are formed between the semiconductor layer 140, and the source electrodes 165 and the drain electrodes 166 to reduce contact resistance therebetween. The ohmic contact members 155 and 156 include amorphous silicon highly doped with silicide or an n-type dopant.

A passivation layer 170 is formed on the data wires 161, 165, 166, 168, and 169. The passivation layer 170 includes an insulating material with low permittivity, such as a-Si:C:O and a-Si:O:F, formed by a plasma enhanced chemical vapor deposition (PECVD) or an inorganic insulating material, such as silicon nitride or silicon oxide.

An organic layer 175 is formed on the passivation layer 170. The organic layer 175 is highly planar and photosensitive. The organic layer 175 limits the electrical capacitance generated between the data lines 161 and the pixel electrode 180.

The plurality of pixel electrodes 180 is formed on the organic layer 175. The pixel electrodes 180 include a transparent conductive material, such as indium tin oxide (ITO) or indium zinc oxide (IZO), or an opaque conductive material, such as aluminum, having good light reflection. The pixel electrodes 180 receive voltages through a column reverse driving method.

The passivation layer 170 and the organic layer 175 include a plurality of contact holes 171 that expose a part of the connectors 169 therethrough. The pixel electrodes 180 and the connectors 169 are connected to each other through the contact holes 171.

The plurality of pixel electrodes 180 includes a first pixel region 181 and a second pixel region 182. At least one first pixel region 181 and one second pixel region 182 may be formed, respectively. FIG. 1 shows a single first pixel region 181 and two second pixel regions 182.

The gate lines 121 cross a center of the pixel electrodes 180. The data lines 161 are formed along a first side of the pixel electrodes 180. The first storage electrode lines 126 and the second storage electrode lines 168 are formed along a second side of the pixel electrodes 180 adjacent to the first side of the pixel electrodes 180.

Hereinafter, the second display panel 200 will be described in detail.

A second substrate 210 includes a transparent material, such as glass, quartz, ceramic, or plastic.

A light blocking member 220 is formed on the second substrate 210. The light blocking member 220 includes an opening part that faces the pixel electrodes 180 of the first display panel 100 and blocks light leaking from the neighboring pixels. The light blocking member 220 is formed corresponding to the thin film transistor 10 to block external light from being incident to the semiconductor layer 140 of the thin film transistor 10. The light blocking member 220 may include a photosensitive organic material and a black pigment to block light. The black pigment may include carbon black or titanium oxide.

Color filters 230 of red, green, or blue color may be sequentially formed on the second substrate 210 having the light blocking member 220. The colors of the color filters 230 are not limited to the three colors and may vary. The color filters 230 may be formed between the light blocking members 220, but are not limited thereto. Alternatively, the color filters 230 may partially overlap each other and may block light like the light blocking member 220. In this case, the light blocking member 220 may be omitted.

An optional planarization layer 240 may be formed on the light blocking member 220 and the color filters 230.

The common electrode 280 may be formed on the planarization layer 240. The common electrode 280 forms an electric field together with the pixel electrodes 180. The common electrode 280 includes a transparent conductive material such as ITO or IZO.

The common electrode 280 includes cutting patterns 281 and 282. The first pixel region 181 and the second pixel region 182 are divided by the cutting patterns 281 and 282 and have two domains facing each other.

The cutting patterns 281 and 282 include a first cutting pattern 281, which corresponds to the first pixel region 181 of the pixel electrodes 180, and a second cutting pattern 282, which corresponds to the second pixel region 182. The first cutting pattern 281 overlaps the gate lines 121. The second cutting pattern 282 crosses the gate lines 121. A fringe field is formed between the first pixel region 181 and the first cutting pattern 281, and between the second pixel region 182 and the second cutting pattern 282. The fringe field determines the orientation, i.e., the alignment direction, of the liquid crystal molecules in the liquid crystal layer 300 provided between the first display panel 100 and the second display panel 200. Thus, the transmittance of light traveling through the panel assembly 901 may be adjusted, thereby displaying the desired image.

The first storage electrode lines 126 and the common electrode 280 receive a first voltage while the second storage electrode lines 168 and the pixel electrodes 180 receive a second voltage different from the first voltage. According to the first exemplary embodiment of the present invention, the first voltage may be 0 V, and the second voltage may be positive or negative. The first voltage is not limited to 0 V, and may vary depending on the driving method.

If the pixel electrodes 180 receive the first voltage, the liquid crystal molecules between the pixel electrodes 180 and the common electrodes 280 remain aligned vertically. If the pixel electrode 180 receives the second voltage, the liquid crystal molecules are oriented in a certain direction due to the fringe field formed between the first pixel region 181 and the first cutting pattern 281, and between the second pixel region 182 and the second cutting pattern 281. Here, the liquid crystal molecules in the first pixel region 181 are oriented toward the first cutting pattern 282, i.e., the long axes of the liquid crystal molecules are parallel to the X axis. The liquid crystal molecules in the second pixel region 182 lie toward the second cutting pattern 282, i.e., the long axes of the liquid crystal molecules are parallel to the Y axis.

If the pixel electrodes 180 receive the second voltage, the fringe field may also be formed between the first storage electrode line 126 and the pixel electrodes 180 that receive the first voltage, thereby affecting the liquid crystal molecules near the boundary of the pixel electrodes 180. The direction of the fringe field formed between the pixel electrodes 180 and the first storage electrode line 126 is the same as that formed in the first pixel region 181, but different than that formed in the second pixel region 182 causing it to collide with the fringe field formed in the second pixel region 182.

If the pixel electrodes 180 receive the second voltage, the second storage electrode lines 168 receive the second voltage too. The degree to which the second storage electrode lines 168 receiving the second voltage overlap the first storage electrode lines 126 receiving the first voltage, determines the size of the fringe field formed between the first storage electrode lines 126 and the pixel electrodes 180.

As shown in FIG. 1 and FIG. 4, the widths of the first storage electrode lines 126 are greater than those of the second storage electrode lines 168 in the region adjacent to the first pixel region 181.

Conversely, as shown in FIG. 1 and FIG. 3, the widths of the first storage electrode line 126 are smaller than those of the second storage electrode lines 168 in the second pixel region 182.

As shown in FIG. 1, the widths of the first storage electrode lines 126 may be constant. The widths of the second storage electrode lines 168 may vary by section, i.e., the second storage electrode lines 168 may be narrower than the first storage electrode lines 126 in a section 1681 of the first pixel electrode region 181, and wider than the first storage electrode lines 126 in a section 1682 of the second pixel region 182, but are not limited thereto. Alternatively, the widths of the second storage electrode lines 168 may be constant while the widths of the first storage electrode lines 126 may vary.

With the foregoing configuration, the strength of the fringe field formed between the first storage electrode line 126 and the pixel electrodes 180 may be adjusted depending on whether the direction of the fringe field formed between the first storage electrode lines 126 and the pixel electrodes 180 is the same as that of fringe fields formed in respective domains in the pixel electrodes 180. Thus, it may be possible to prevent the appearance of texture. Texture may appear when fringe fields in different directions collide with each other, thereby distorting the alignment of the liquid crystal molecules.

The widths of the second storage electrode lines 168 in the first pixel region 181 may be smaller than those of the first storage electrode lines 126. In the first pixel region 181, the direction of the fringe field formed between the first storage electrode lines 126 and the pixel electrodes 180 may be the same as that formed in the pixel electrodes 180. Thus, the fringe field of the pixel electrodes 180 may be combined with the fringe field formed between the first storage electrode lines 126 and the pixel electrodes 180, thereby aligning the liquid crystal molecules in the first pixel region 181 more efficiently.

On the other hand, the width of the second storage electrode lines 168 adjacent to the second pixel region 182 may be greater than the width of the first storage electrode lines 126. In the second pixel region 182, the direction of the fringe field formed between the first storage electrode lines 126 and the pixel electrodes 180 is different from that formed in the pixel electrodes 180. The formation of a fringe field between the pixel electrodes 180 and the first storage electrode line 126 may be prevented by overlapping the first storage electrode lines 126, which receive a voltage that is the same as that supplied to the common electrode 280 and different from that supplied to the pixel electrodes 180, with the second storage electrode lines 168, which receive the same voltage as the pixel electrodes 180. Then, the collision of the fringe field formed between the pixel electrodes 180 and the first storage electrode line 126 and the normal fringe field formed in the second pixel region 182 may be prevented, thereby allowing the alignment direction of the liquid crystal molecules to be controlled.

Thus, the appearance of texture may be prevented, thereby improving the brightness level and uniformity of the display panel 901.

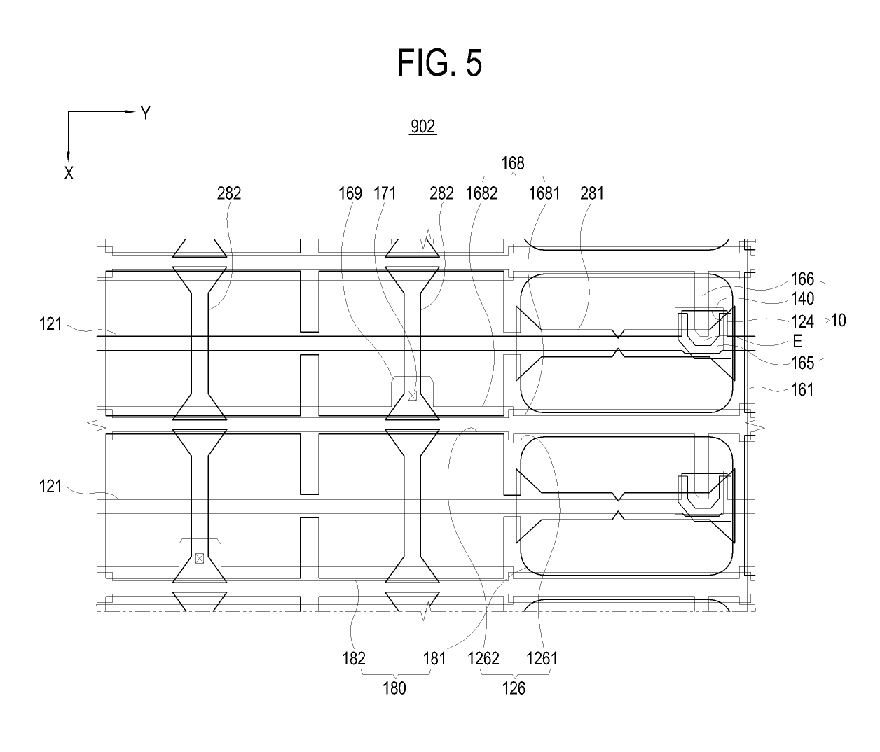

Hereinafter, a display panel 902 according to a variation of the first exemplary embodiment of the present invention will be described with reference to FIG. 5.

As shown therein, the widths of the first storage electrode lines 126 and the second storage electrode lines 168 may vary by section. That is, portions 1261 of the first storage electrode lines 126 in the first pixel region 181 may be wider than portions 1262 of the first storage electrode lines 126 in the second pixel region 182. The sections 1682 of the second storage electrode lines 168 in the second pixel region 182 may be wider than the sections 1681 of the second storage electrode lines 168 in the first pixel region 181. The widths of the first storage electrode lines 126 in the first pixel region 181 may be wider than those of the second storage electrode line 168. The width of the second storage electrode line 168 in the second pixel region 182 may be wider than those of the first storage electrode line 126. Thus, the first storage electrode lines 126 in the first pixel region 181 may be exposed while the first storage electrode lines 126 in the second pixel region 182 may be covered by the second storage electrode line 168.

With the foregoing configuration, the strength of the fringe field formed between the first storage electrode lines 126 and the pixel electrodes 180 may be adjusted depending on whether the direction of the fringe field formed between the first storage electrode lines 126 and the pixel electrodes 180 is the same as the fringe field formed in the pixel electrodes 180. Thus, the collision between fringe fields in different directions and the uncontrollable alignment direction of the liquid crystal molecules may be avoided, thereby preventing the appearance of texture. Also, the level and uniformity of the brightness of the panel assembly 902 may be improved due to the non-occurrence of texture.

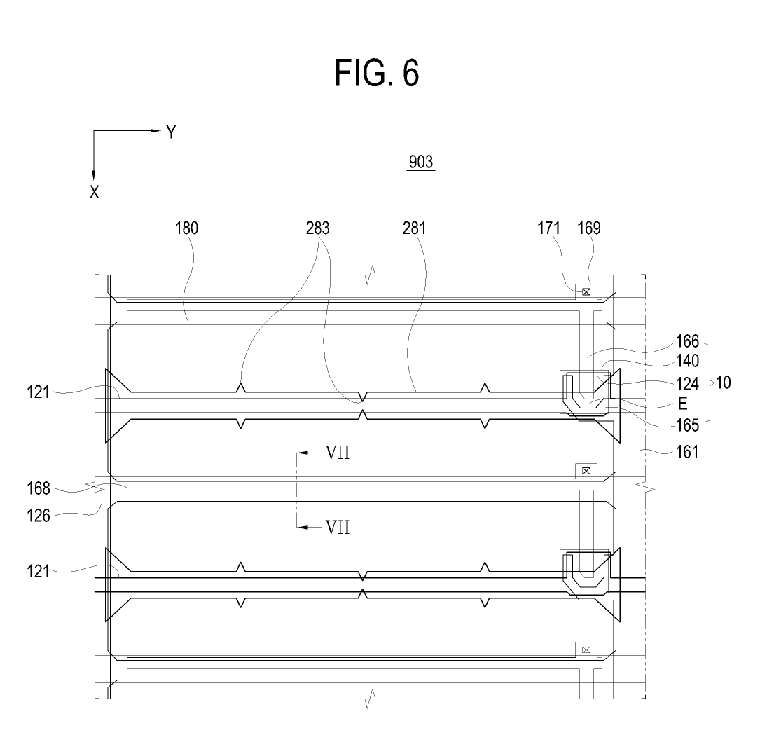

Hereinafter, a panel assembly 903 according to a second exemplary embodiment of the present invention will be described with reference to FIG. 6.

As shown therein, a gate line 121 crosses a center of a pixel electrode 180. A data line 161 is arranged along a first side of the pixel electrode 180. A first storage electrode line 126 and a second storage electrode line 168 are arranged along a second side of the pixel electrode 180, which is adjacent to the first side of the pixel electrode 180.

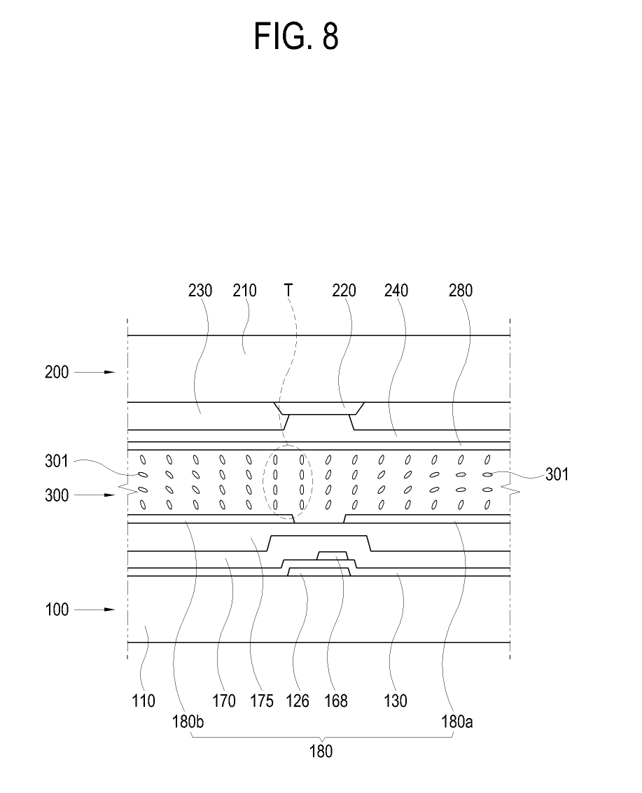

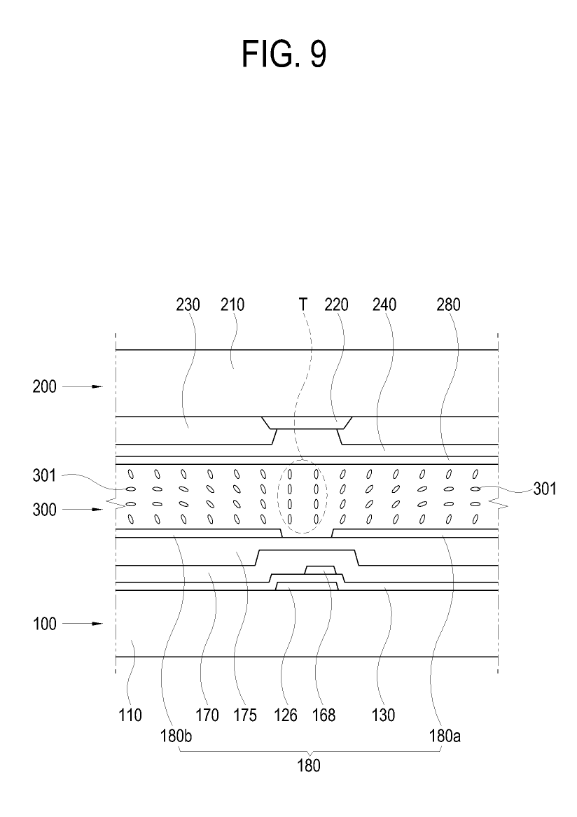

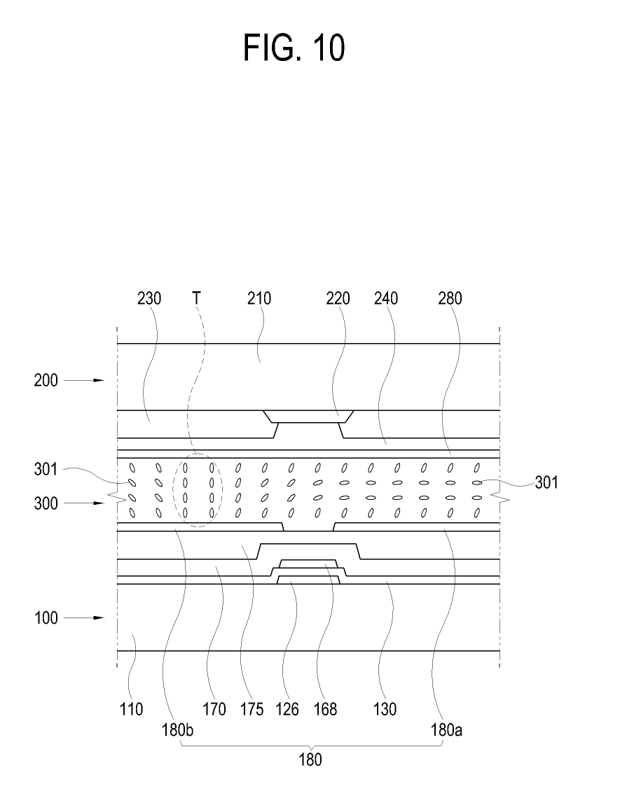

A common electrode 280 (refer to FIG. 8) includes a cutting pattern 281 which is formed parallel to the gate line 121 and divides the pixel electrodes 180 into two domains. The cutting pattern 281 overlaps the gate line 121. That is, the cutting pattern 281 divides the pixel electrode 180 into two domains. The cutting pattern 281 includes at least one notch 283, which is alternately arranged. The notch 283 formed in the cutting pattern 281 may allow liquid crystal molecules to be aligned more stably.

The overall width of the first storage electrode line 126 may be wider than that of the second storage electrode line 168. The second storage electrode line 168 overlaps only a first periphery part of the first storage electrode line 126, thereby exposing a second periphery part of the first storage electrode line 126.

A second voltage is sequentially supplied to the pixel electrodes 180 in the direction of the X axis, i.e., from the first periphery part of the first storage electrode line 126 that overlaps the second storage electrode line 168 to the pixel electrodes 180 of the second periphery part of the first storage electrode line 126.

With the foregoing configuration, texture occurring between the pixel electrodes 180 may be efficiently controlled, thereby improving the transmittance of light traveling through the panel assembly 903.

If a pixel electrode 180 receives the second voltage and a second adjacent pixel electrode 180 receives the second voltage while having the first voltage smaller than the second voltage, texture instantly occurs in the second pixel electrode 180.

Then, the alignment of the liquid crystal molecules may be controlled by the fringe field formed between the first storage electrode line 126 and the pixel electrodes 180, thereby limiting the occurrence of texture in the pixel electrodes 180.

The effect obtained when the second electrode line 168 overlaps one periphery part of the first electrode line 126 is also applicable to a configuration in which a pixel electrode 180 is divided into a plurality of pixels regions 181 and 182 (refer to FIG. 1) that have fringe fields with differing directions.

Hereinafter, the panel assembly 903 according to the second exemplary embodiment of the present invention will be described in detail with reference to an Experimental Embodiment.

The Experimental Embodiment is provided to exemplify the present invention. The present invention is not limited thereto.

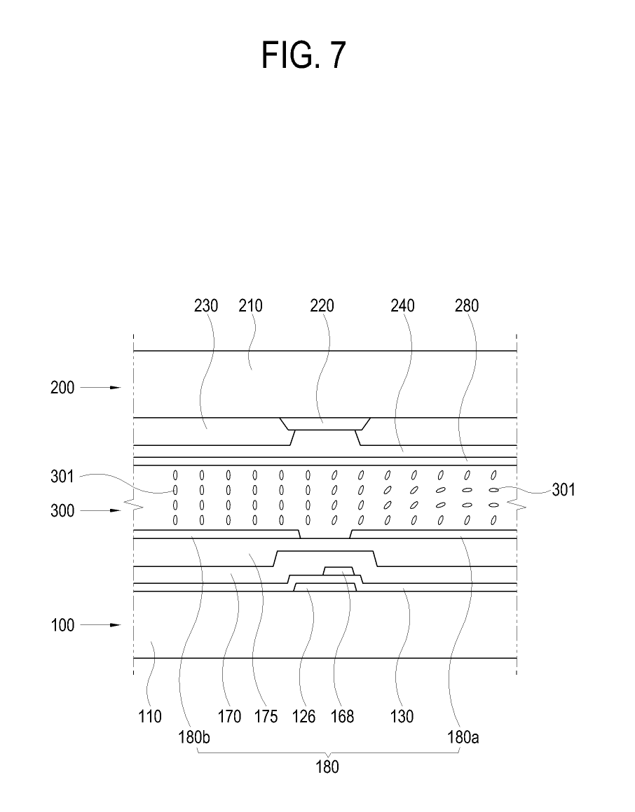

FIG. 7, FIG. 8, and FIG. 9 show the alignment of a liquid crystal molecule 301 when a pixel electrode 180 receives a voltage, according to the experimental embodiment of the second exemplary embodiment of the present invention.

### Experimental Embodiment

In the Experimental Embodiment, a second storage electrode line 168 is formed closer to one pixel electrode 180a than another pixel electrode 180b, leaving a part of a first storage electrode line 126 close to the other pixel electrode 180b exposed instead of overlapped by the second storage electrode line 168.

FIG. 7 shows a pixel electrode 180a that receives a second voltage, e.g., 5 V, and another pixel electrode 180b that receives a first voltage, e.g., 0 V. A common electrode 280 always receives the first voltage. As shown therein, the alignment of the liquid crystal molecules 301 in the region of the pixel electrode 180a receiving 5 V is affected by a fringe field. Meanwhile, the liquid crystal molecules 301 in the region of the pixel electrode 180b receiving 0 V are vertically aligned.

FIG. 8 shows a first pixel electrode 180a that receives the second voltage while another pixel electrode 180b receives an intermediate voltage between the first and second voltages. The other pixel electrode 180b in FIG. 8 receives a voltage of approximately 3 V. Thus, the liquid crystal molecules 301 in the region of the other pixel electrode 180b also are affected by the fringe field. However, as the other pixel electrode 180b has a smaller voltage difference with the common electrode 280 than the pixel electrode 180a, the liquid crystal molecules 301 in the region of the other pixel electrode 180b are less affected by the fringe field. Thus, texture T formed between the liquid crystal molecules 301 aligned in different directions moves toward pixel electrode 180b where the liquid crystal molecules 301 are less affected.

As shown in FIG. 8, the second storage electrode line 168 is formed between the pixel electrodes 180a and 180b. The fringe field formed between the first storage electrode line 126 and the other pixel electrode 180b is stronger than the fringe field formed between the first storage electrode line 126 and the pixel electrode 180a. That is, the fringe field formed between the first storage electrode line 126 and the other pixel electrode 180b intensifies the alignment of the liquid crystal molecules 301 in the region of pixel electrode 180b. Thus, the texture T may be prevented from moving toward the other pixel electrode 180b.

FIG. 9 shows two pixel electrodes 180a and 180b that receive the second voltage. As shown therein, if a voltage supplied to the other pixel electrode 180b reaches the second voltage, the liquid crystal molecules 301 in the respective regions of the pixel electrodes 180a and 180b are aligned with balance. Thus, the texture T that was closer to the pixel electrode 180b may be formed in a boundary between the pixel electrodes 180a and 180b and does not move away from the boundary of the two pixel electrodes 180a and 180b.

### Comparison Embodiment

In the Comparison Embodiment, a second storage electrode line 168 is formed in a center of a first storage electrode line 126. Other than that, under the same conditions as the Experimental Embodiment, a pixel electrode 180a receives a second voltage and another pixel electrode 180b receives the second voltage while being supplied with a first voltage.

As shown in FIG. 10, if pixel electrode 180b receives approximately 3 V, liquid crystal molecules 301 in the region of pixel electrode 180b are less affected by the electric field since pixel electrode 180b has a smaller voltage difference with a common electrode 280 than pixel electrode 180a. Thus, texture T formed between the liquid crystal molecules 301 aligned in different directions significantly moves toward pixel electrode 180b.

As shown by the foregoing Experimental Embodiment and Comparable Embodiment, the present invention may have a significant effect. In the Experimental Embodiment, the transmittance of light traveling through the panel assembly 903 may be prevented from being lowered by texture.

As described above, the present invention provides a panel assembly which may have enhanced transmittance of light traveling through a panel assembly.

That is, texture may be prevented from occurring because fringe fields in different directions do not collide with each other to distort the alignment direction of liquid crystal molecules. Thus, the level and uniformity of brightness of a panel assembly may be improved due to the non-occurrence of texture.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A panel assembly, comprising:
gate wires comprising a plurality of gate lines and a plurality of first storage electrode lines parallel to the gate lines;
data wires comprising a plurality of data lines crossing the gate lines and a plurality of second storage electrode lines overlapping the first storage electrode lines and spaced apart from the data lines, the data wires being insulated from the gate wires;
a plurality of pixel electrodes disposed on and insulated from the data wires;
a liquid crystal layer disposed on the pixel electrodes, the liquid crystal layer comprising liquid crystal molecules; and
a common electrode disposed on the liquid crystal layer,
wherein the plurality of first storage electrode lines or the plurality of second storage electrode lines have different widths in different sections of the lines.

2. The panel assembly of claim 1, wherein the gate lines cross a center of the pixel electrodes, and
the first storage electrode lines, the second storage electrode lines, and the data lines are arranged along a boundary of the pixel electrodes.

3. The panel assembly of claim 2, wherein the data lines are arranged along a first side of the pixel electrodes, and
the first storage electrode lines and the second storage electrode lines are arranged along a second side of the pixel electrodes, the second side being adjacent to the first side.

4. The panel assembly of claim 3, wherein the first storage electrode lines and the common electrode receive a first voltage, and
the pixel electrodes and the second storage electrode lines receive a second voltage which is larger or smaller than the first voltage.

5. The panel assembly of claim 4, wherein the first voltage is 0 volts.

6. The panel assembly of claim 4, wherein the pixel electrodes receives voltages through a column reverse driving method.

7. The panel assembly of claim 4, wherein the pixel electrodes are divided into at least one first pixel region and at least one second pixel region, and
a first cutting pattern is disposed in a first region of the common electrode corresponding to the first pixel region, the first cutting pattern being parallel to the gate lines and dividing the first pixel region, and
a second cutting pattern is disposed in a second region of the common electrode corresponding to the second pixel region, the second cutting pattern crossing the gate lines and dividing the second pixel region.

8. The panel assembly of claim 7, wherein the first cutting pattern overlaps the gate lines.

9. The panel assembly of claim 7, wherein the first storage electrode lines have greater widths than the second storage electrode lines in the first pixel region, and
the first storage electrode lines have smaller widths than the second storage electrode lines in the second pixel region.

10. The panel assembly of claim 9, wherein one of the first storage electrode lines and the second storage electrode lines has a constant width while the other has a varying width.

11. The panel assembly of claim 9, wherein the widths of the first storage electrode lines and the second storage electrode lines are different in different sections of the lines.

12. The panel assembly of claim 2, wherein the width of the plurality of first storage electrode lines is greater than that of the second storage electrode lines.

13. The panel assembly of claim 12, wherein the second storage electrode lines overlap first periphery parts of the first storage electrode lines while exposing second periphery parts of the first storage electrode lines.

14. The panel assembly of claim 13, wherein the second voltage is sequentially supplied from a pixel electrode adjacent to the first periphery part of the first storage electrode line overlapped by the second storage electrode line to a pixel electrode adjacent to the second periphery part of the first storage electrode line.

15. The panel-assembly of claim 14, wherein the common electrode comprises a cutting pattern that is parallel to the gate lines and divides the pixel electrode, and the cutting pattern overlaps the gate lines.

16. The panel assembly of claim 14, wherein the pixel electrodes are divided into one first pixel region and at least one second pixel region, and
a first cutting pattern is disposed in a first region of the common electrode corresponding to the first pixel region, the first cutting pattern being parallel to the gate lines and dividing the first pixel region, and
a second cutting pattern is disposed in a second region of the common electrode corresponding to the second pixel region, the second cutting pattern crossing the gate lines and dividing the second pixel region.

17. The panel assembly of claim 16, wherein the first cutting pattern overlaps the gate lines.
